(19) United States
(12) Patent Application Publication
(10) Pub. No.: US 2006/0035069 A1
(43) Pub. Date: Feb. 16, 2006

(54) Thermal sheet having higher flexibility and higher heat conductivity

(75) Inventor: Nobuaki Hanai, Tokyo (JP)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 11/187,509

(22) Filed: Jul. 22, 2005

(30) Foreign Application Priority Data
Aug. 13, 2004 (JP) 2004-235825

(51) Int. Cl. B32B 3/00

(52) U.S. Cl. 428/316.6; 428/319.1; 428/319.3; 428/319.7

(57) ABSTRACT

A heat-conducting member having a three-layer structure. A heat-conducting member which comprises a substrate made from urethane foam. The entire substrate is coated by a heat-conducting coating material, which is a cloth made from copper fibers and Nylon™. Substrate coated by heat-conducting coating material is further coated by electricity-insulating coating material made from polyimide resin such that it covers over the entire heat-conducting coating material.

### 1. FIELD OF THE INVENTION

The present invention pertains to a heat-conducting member used for heat radiation, heat transfer, and the like, and relates to a heat-conducting member that is very flexible and has a high heat conductivity.

### 2. DISCUSSION OF THE BACKGROUND ART

Electronic devices comprise ICs and other semiconductor components as well as resistors and other electronic components mounted on printed circuit boards. These semiconductor components and electronic components generate heat when the electronic device is operating. The heat that is generated from these components is usually transferred and radiated through heat-conducting members to an electronic device housing or heat sink or other heat-radiating member.

Terminology will now be defined here. Heat conduction means that heat is transmitted within the same element or the same object. Moreover, heat-transfer means that heat is transmitted between different elements or different objects.

Conventional heat-conducting members are liquid heat sinks, thermal sheets, or packs filled with a metal that is not in ingot form (refer to J P (Kokai) Unexamined Patent Publication 6[1994]-268,113 (pages 2 and 3, FIGS. 1, 3 and 4), for example).

These conventional heat-conducting members do not simultaneously satisfy the properties of being very flexible and having a high heat conductivity. As a result, sufficient heat transfer is not realized with conventional heat-transfer members. Moreover, conventional heat-conducting members are not appropriate for repeated use in different electronic devices or different printed circuit boards, and the like.

For instance, the resin bag of a liquid heat sink filled with an electricity-insulating liquid deforms; therefore, it closely adheres to heat-conducting parts, housing, and the like, and there is no plastic deformation. However, the heat conductivity of the liquid of a liquid heat sink is low in comparison to that of an individual metal; therefore, there are cases in which sufficient heat conduction cannot be realized. Moreover, there is a risk that the liquid inside will leak if the bag is damaged.

Thermal sheets have high heat conductivity when compared to liquid heat sinks, but they do not closely adhere to heat-generating components, housing, and the like. For instance, adhesion to these components is compromised when one thermal sheet is used repeatedly for many components of different shapes. Even when one thermal sheet is used for one type of component, the height of the components may vary, the finishing precision of the walls of the housing may vary, and the distance between the heat-generating components and heat-radiating components may vary with the product due to floating solder, and the like. Therefore, the thermal sheets that are introduced in between these components must be thick and flexible enough to respond to these conditions. In other words, special working and shaping of these thermal sheets become necessary in order to partially layer the sheets, cut out unnecessary parts, and the like. Moreover, heat resistance changes with the thickness of the thermal sheet and tends to vary with the temperature of the heat-generating component.

A pack filled with a metal that is not in ingot form has a high heat conductivity when compared to liquid heat sinks or thermal sheets and will closely adhere to heat-generating components, housing, and the like when compared to a thermal sheet. However, steel wool is used for the metal inside the pack; therefore, plastic deformation readily occurs. There will also be a reduction in the heat transfer of a pack that has undergone plastic deformation because there will not be sufficient contact when it is used for printed circuit boards having components of different shapes mounted at different positions.

In short, with conventional heat-conducting members it is necessary to redesign the heat-conducting member to match a new printed circuit board, and the like each time housing for an electronic device or a printed circuit board is produced in a trial run. Moreover, heat transfer is reduced with heat-conducting members that are not redesigned with every trial production. Therefore, an object of the present invention is to provide a heat-conducting member that is a very flexible heat-conducting member and has a higher heat conductivity than in the past. Another object of the present invention is to provide a heat-conducting member that can be reused regardless of the shape of the object to which it will adhere.

### SUMMARY OF THE INVENTION

The present invention is a heat-conducting member characterized in that it comprises an elastic deforming substrate; a first coating material with which the substrate is coated and which is heat-conductive and flexible enough for deformation under the elastic force of the substrate; and a second coating material with which the first coating material is coated and which is heat-conductive, electricity-insulating, and flexible enough to deform under the elastic force of the substrate, with the heat conductivity of the first coating material being higher than the heat conductivity of the substrate and of the second coating material.

An additional embodiment of the present invention is a heat-conducting member, characterized in that it comprises an elastic deforming substrate and a first coating material with which the substrate is coated and which is heat-conductive, electricity-insulating, and flexible enough to deform under the elastic force of the substrate, with the heat conductivity of the first coating material being higher than the heat conductivity of the substrate.

Still yet another embodiment according to the present invention is a heat-conducting member, characterized in that it comprises a plurality heat-transfer elements, each of which consists of a substrate with which each heat-transfer element elastically deforms and a first coating material with which the substrate is coated and which is heat-conductive and flexible enough to deform under the elastic force of the substrate, and a second coating material that collectively coats the plurality of heat-transfer elements and is heat-conductive, electricity-insulating, and flexible enough to deform under the elastic force of the substrate, with the heat conductivity of the first coating material being higher than the heat conductivity of the substrate and of the second coating material.

Preferably, the heat-conducting member is characterized in that the first coating material is cloth or a net made from metal fibers or cloth or a net made from metal fibers and non-metal fibers.

Optionally, the heat-conducting member is characterized in that the substrate is a high polymer foam.

By means of the present invention, it is possible to provide a heat-conducting member that is very flexible when compared to the prior art and is very capable of adhering to heat-generating parts of different shapes and sizes. Moreover, by means of the present invention, it is possible to use metal cloth, and the like as the heat-transfer member; therefore it is possible to provide a heat-conducting member that has a higher heat conductivity than in the prior art while retaining flexibility. The heat-transfer member of the present invention realizes better heat transfer than in the prior art as a result of the multiplied effect of being very flexible and having a high heat conductivity. Furthermore, by means of the present invention, it is possible to provide a heat-conducting member with uniform heat resistance. By means of the present invention, it is possible to provide a heat-conducting member that can be repeatedly used on objects of different shapes and sizes. In addition, the part of the heat-conducting member of the present invention that contacts a heat-generating body has electrical resistance; therefore, the heat-conducting member of the present invention is ideal for electronic devices.

### BRIEF DESCRIPTION OF THE DRAWINGS

FIG. 1 is a cross section showing the housing; the printed circuit board; and the heat-conducting members 100 disposed [in two places] between the housing and printed circuit board.

FIG. 2 is a partial oblique view of heat-conducting member 100.

FIG. 3 is a cross section of heat-conducting member 100.

FIG. 4 is a partial oblique view of heat-conducting member 300.

FIG. 5 is a cross section of heat-conducting member 300.

### DETAILED DESCRIPTION OF THE PREFERRED EMBODIMENT

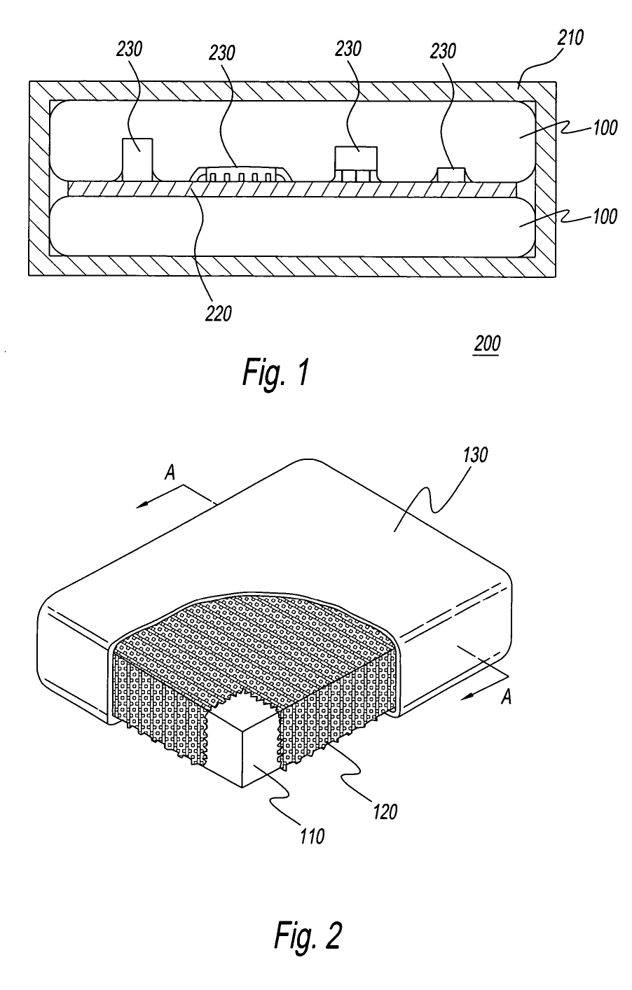

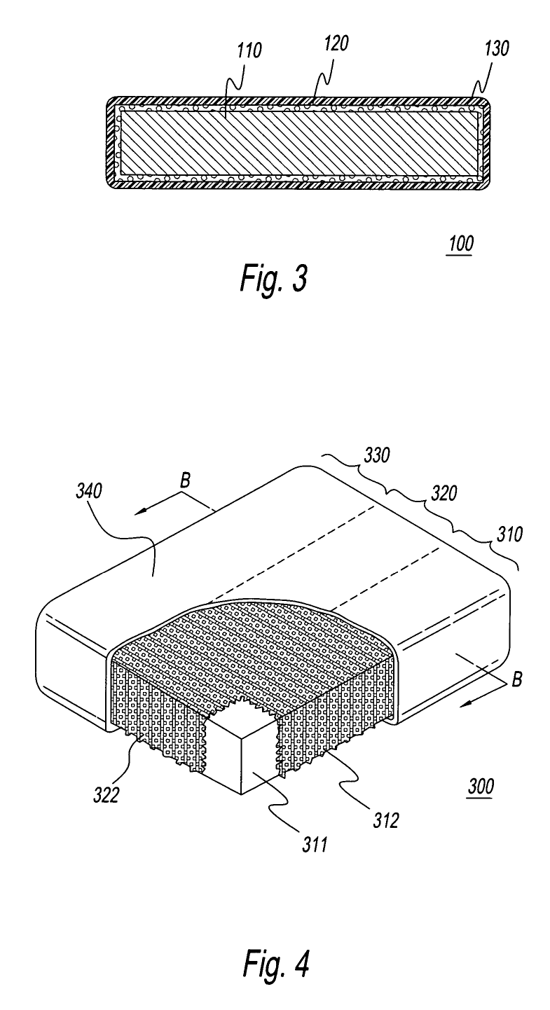

The present invention will now be explained in detail based on the embodiments shown in the attached drawings. The first embodiment of the present invention is a heat-conducting member 100. FIG. 1 is a cross-section showing an electronic device having a housing, a printed circuit board, and heat-conducting member 100 disposed between the housing and the printed circuit board. Moreover, FIG. 2 is a partial oblique view of heat-conducting member 100. Furthermore, FIG. 3 is the A-A cross-section of FIG. 2.

Now refer to FIG. 1. One heat-conducting member 100 as shown in the drawing is disposed inside a housing 210 of an electronic device 200 between the top surface of a printed circuit board 220 and housing 210 and another heat-conducting member 100 is disposed between the bottom surface of printed circuit board 220 and housing 210. ICs, resistors, and other heat-generating components 230 are mounted on the top and bottom surfaces of printed circuit board 220. The cross section of heat-conducting member 100 is simplified in FIG. 1 and the details are shown in FIG. 3.

Now refer to FIGS. 2 and 3. Heat-conducting member 100 in the drawings has a three-layer structure. Heat-conducting member 100 comprises a base material 110 made from urethane foam. The entire base material 110 is coated with a heat-conductive coating material 120, which is a cloth made from copper fibers and Nylon™. Base material 110 coated with heat-conducting coating material 120 is further coated with an electricity-insulating coating material 130 made from polyimide resin such that it covers over the entire heat-conducting coating material 120.

Base material 110 can be any material as long as it is elastically deforming and is not limited to urethane foam. For instance, a soft rubber, a member made of multiple rows of microsprings, or a pack filled with a liquid or gel can be used in place of urethane foam as base material 110. It should be noted that elastic deformation means the ability to recover from deformation and return to the original state when stress is eliminated.

Heat-conducting coating material 120 can be any material as long as it is a material that is heat-conducting and flexible enough to deform under the elastic force of base material 110, and it is not limited to cloth made from copper fibers and Nylon™. For instance, heat-conducting coating material 120 can be a metal cloth or grid, a carbon fiber cloth, metal foil, or a resin filled with metal powder. Heat-conducting coating material 120 is preferably in a copper net, aluminum net, or carbon fiber cloth when the coating material must easily deform and be resistant to deformation. It should be noted that heat-conducting coating material 120 has a higher heat conductivity than base material 110 or electricity-insulating coating material 130.

Electricity-insulating coating material 130 can be any material that is heat-conducting, electricity-insulating, and flexible enough to deform under the elastic force of base material 110 and is not limited to a polyimide resin. For instance, a silicone resin or fluorine rubber can be used for electricity-insulating coating material 130. Electricity-insulating coating material 130 is not necessary when heat-conducting coating material 120 is electricity-insulating by itself. For instance, heat-conducting member 100 does not require electricity-insulating coating material 130 when heat-conducting coating material 120 is a cloth made from alumite-treated aluminum fibers.

The heat that is generated from the IC, resistor, or other heat-generating component 230 is transferred directly by heat-conducting member 100 made as described above to electricity-insulating coating material 130, or indirectly through printed circuit board 220. The heat that has been transferred to electricity-insulating coating material 130 is transferred to heat-conducting coating material 120. Furthermore, heat is transferred from heat-conducting coating material 120 through electricity-insulating coating material 130 to housing 210. Heat transfer from heat-conducting coating material 120 is heat transfer through an object with excellent heat conductivity; therefore, there is strong heat conduction when compared to a liquid heat sink or a thermal sheet.

Heat-conducting member 100 freely changes shape; therefore, it will adhere close to heat-generating component 230 on the printed circuit board and housing 210 without being cut, layered, and the like. Base material 110 is a member capable of elastic deformation, and heat-conducting coating material 120 and electricity-insulating coating material 130 deform together with base material 110; therefore, the entire heat-conducting member 100 is capable of elastic deformation. Thus, even if the position or shape of heat-generating component 230 and housing 210 changes, heat-conducting member 100 can be repeatedly used without further treatment with virtually no reduction in heat transfer.

In addition, when a bag filled with liquid or gel is used as base material 110, heat-conducting coating material 120 will protect base material 110 if a material that will not be damaged by outside force, such as a metal cloth with a fine mesh, is used for heat-conducting coating material 120. Thus, heat-conducting member 100 has little chance of liquid leaking when compared to liquid heat sinks.

Nevertheless, heat conduction by heat-conducting member 100 is performed principally by heat-conducting coating material 120. In short, heat conduction by heat-conducting member 100 occurs along the surface of heat-conducting member 100. This leads to several inconveniences. For instance, there are cases where there is an increase in variations in the length of the heat conduction path from the heat-generating body to the heat-radiating member with an increase in the size of heat-conducting member 100, leading to variations in heat conductivity. In addition, there are also cases where there is reduction in overall heat transfer.

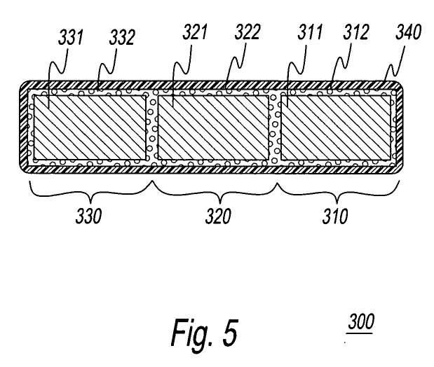

Therefore, a second embodiment of the present invention that solves these problems will be described while referring to the drawings. The second embodiment of the present invention is heat-conducting member 300. FIG. 4 is a partial oblique view of heat-conducting member 300. FIG. 5 is the B-B cross section of FIG. 4.

Refer to FIGS. 4 and 5. Heat-conducting member 300 in the drawings comprises heat-conducting elements 310, 320, and 330. Heat-conducting element 310 comprises a base material 311 made from urethane foam. The entire base material 311 is coated by a heat-conducting coating material 312, which is a cloth made from copper fibers and Nylon™. Heat-conducting element 320 comprises a base material 321 made from urethane foam. The entire base material 321 is coated by a heat-conducting coating material 322, which is a cloth made from copper fibers and Nylon™. Heat-conducting member 330 comprises a base material 331 made from urethane foam. The entire base material 331 is coated by a heat-conducting coating material 332, which is cloth made from copper fibers and Nylon™. Heat-conducting members 310, 320, and 330 are further coated as one unit by an electricity-insulating coating material 340 made from polyimide resin.

Heat-conducting members 310, 320, and 330 can be of the same shape or different shapes. Moreover, base materials 311, 321, and 331 have the same properties as base material 110. In addition, heat-conducting coating materials 312, 322, and 332 have the same properties as heat-conducting coating material 120. Electricity-insulating coating material 340 has the same properties as electricity-insulating coating material 130. For instance, base material 311 can be made from a soft rubber, and the like; heat-conducting coating material 312 can be an aluminum net, and the like; and electricity-insulating coating material 340 can be a silicone resin, and the like.

By means of heat-conducting member 300 made as described above, the heat generated by an IC, resistor, or other heat-generating component is directly or indirectly transferred to electricity-insulating coating material 340. The heat that has been transferred to electricity-insulating coating material 340 is transferred to heat-conducting coating material 312, 322, or 332. The heat is further transferred from heat-conducting coating material 312, 322, or 332 through electricity-insulating coating material 340 to the housing or other heat-radiating member. Thus, heat-conducting member 300 comprises a plurality of heat-transfer paths on the inside. As a result, variations in the length of the heat-transfer path from the heat-generating body to the heat-radiating member can be reduced with heat-conducting member 300 when compared to heat-conducting member 100. In addition, the reduction in heat transfer that accompanies an increase in the size of the heat-conducting member can be controlled. Of course, heat-conducting member 300 has the characteristics of the above-mentioned heat-conducting member 100.

It should be noted that the number of heat-conducting elements inside heat-conducting member 300 is not limited to three; there can be two elements or 4 or more elements. The heat-conducting elements inside heat-conducting member 300 can be disposed one-dimensionally, two-dimensionally, or three-dimensionally. The shape of the heat-conducting elements inside heat-conducting member 300 is not restricted to cuboid; they can be cylindrical, spherical, or another shape. This is also true for the substrate of the heat-conducting elements. This also holds true for base material 110 by itself and base material 110 after it is coated with heat-conducting coating material 120 in the first embodiment.

What is claimed is:

1. A heat-conducting member which comprises:
an elastic deforming base material;
a first coating material with which the base material is coated and which is heat-conductive and flexible enough for deformation under the elastic force of the base material; and
a second coating material with which the first coating material is coated and which is heat-conductive, electricity-insulating, and flexible enough to deform under the elastic force of the base material,
wherein said heat conductivity of the first coating material is higher than said heat conductivity of said base material and of said second coating material.

2. The heat-conducting member according to claim 1, wherein said first coating material is at least one material selected from said group consisting of: cloth, a net made from metal fibers or cloth, and a net made from metal fibers and non-metal fibers.

3. The heat-conducting member according to claim 1, wherein said base material is a high polymer foam.

4. A heat-conducting member which comprises:
an elastic deforming base material; and
a first coating material with which the base material is coated and which is heat conductive, electricity-insulating, and flexible enough to deform under the elastic force of the base material,
wherein said heat conductivity of the first coating material is higher than the heat conductivity of the base material.

5. The heat-conducting member according to claim 4, wherein said first coating material is at least one material selected from said group consisting of: cloth, a net made from metal fibers or cloth, and a net made from metal fibers and non-metal fibers.

6. The heat-conducting member according to claim 4, wherein said base material is a high polymer foam.

7. A heat-conducting member which comprises:
a plurality of heat-transfer elements, each said heat-transfer element comprising a base material with which each heat-transfer element elastically deforms;
a first coating material with which the base material is coated and which is heat-conductive and flexible enough to deform under the elastic force of the base material; and
a second coating material that collectively coats the plurality of heat-transfer elements and is heat-conducting, electricity-insulating, and flexible enough to deform under the elastic force of the base material;
wherein said heat conductivity of the first coating material is higher than the heat conductivity of the base material and of the second coating material.

8. The heat-conducting member according to claim 7, wherein said first coating material is at least one material selected from said group consisting of: cloth, a net made from metal fibers or cloth, and a net made from metal fibers and non-metal fibers.

9. The heat-conducting member according to claim 7, wherein said base material is a high polymer foam.
